(19) United States
(12) Patent Application Publication
(10) Pub. No.: US 2002/0082872 A1
(43) Pub. Date: Jun. 27, 2002

(54) Estimation requesting method and system in electronic business

(75) Inventor: Miyoshi Aoki, Tokyo (JP)

Correspondence Address: McDermott, Will & Emery, 600 13th Street, N.W., Washington, DC, 20005-3096, US

(73) Assignee: Mitsubishi Denki Kabushiki Kaisha

(21) Appl. No.: 09/888,390

(22) Filed: Jun. 26, 2001

(30) Foreign Application Priority Data
Dec. 12, 2000 (JP) 2000-377580

(51) Int. Cl. G06F 17/60

(52) U.S. Cl. 705/4

(57) ABSTRACT

To provide an estimation requesting method and system that enable quick estimation requesting and are free of security-related problems. Estimation requesting document form information is stored in advance in a server of a order recipient company that is connected to an Internet. An information desiring person calls an estimation requesting document form from a homepage of the company, inputs prescribed items to the estimation requesting document form, and sending a completed estimation requesting document to the company. In this manner, the information desiring person directly requests the company to make an estimate.

### BACKGROUND OF THE INVENTION

1. Field of the Invention

The present invention relates to an estimation requesting method and system in electronic business. In particular, the invention relates to a estimation requesting method and system that enable to request estimation online over an Internet.

2. Background Art

Nowadays an estimate of car insurance or the like is made usually in the following manner. A person who needs information requests, by telephone, an insurance company or the like to send an estimation requesting document form, writes necessary items on an estimation requesting document form that is sent by fax or mail, and returns a completed estimation requesting document. A written estimate is sent from the insurance company several days later.

Further, as disclosed in Japanese Patent Laid-Open No. 2000-222482, the following electronic commerce assisting system is known. A user refers to goods list and calls an estimation requesting document form by accessing an information management computer (hereinafter referred to as “server”) of an intermediary (hereinafter referred to as “providers”) from the user's personal computer over the Internet, and inputs information relating to goods for which the user needs an estimate to the estimation requesting document form, and returns a completed estimation requesting document. The user can receive written estimates from a plurality of information suppliers (hereinafter referred to as “order recipient companies”) that access the server of the provider separately from the user.

### SUMMARY OF THE INVENTION

Of the above conventional estimation requesting systems, the case in which requesting is made by telephone has a problem that it takes about one week to receive an estimate, that is, necessary estimate information cannot be obtained in a timely fashion.

The case in which requesting is made over the Internet also has the following problems. Although estimate information can be obtained quickly, because of the intermediary provider-involving system, this system is problematic in terms of security; for example, user information may be passed to a plurality of companies without permission of the user. In particular, it is difficult to apply this system to estimation in fields in which personal information should be secured as exemplified by insurance such as car insurance.

The present invention has been achieved to solve the above problems in the art, and an object of the invention is therefore to provide an estimation requesting method and system that enable quick estimation requesting and are free of security-related problems.

According to an aspect of the present invention, in an estimation requesting method in electronic business, estimation requesting document form information is stored in advance in a server of an information supplier that is connected to an Internet. An estimation requesting document form is called from a homepage of the information supplier by an information desiring person. Prescribed items are inputted to the estimation requesting document form. A completed estimation requesting document is sent to the information supplier. Further the information desiring person directly requests the information supplier to make an estimate.

According to another aspect of the present invention, in an estimation requesting method in electronic business, estimation requesting document form information is stored in advance in a server of an information supplier that is connected to an Internet. A function of urging an information desiring person to input desired service contents to an estimation requesting document form is given the server, when the information desiring person has called the estimation requesting document form from a homepage of the information supplier. Prescribed items are inputted to the estimation requesting document form. A completed estimation requesting document is sent to the information supplier. Further the information desiring person directly requests the information supplier to make an estimate.

According to a still further aspect, the present invention provides an estimation requesting system in electronic business, comprising a server of an information supplier connected to a terminal apparatus of an information desiring person through an Internet. The server comprises a main program, an estimation requesting document form information file, an estimation requesting document information file having service contents to be input to an estimation requesting document form, which are stored in advance in the server. The server comprises an input/output control section for urging the information desiring person to input desired service contents when he has called, through the terminal apparatus, the estimation requesting document form from a homepage of the information supplier. And the server comprises a control section for performing processing according to the main program.

### BRIEF DESCRIPTION OF THE DRAWINGS

FIG. 1 is a schematic diagram showing the configuration of a first embodiment of the present invention;

FIG. 2 is a flowchart showing the operation of the first embodiment.

### DETAILED DESCRIPTION OF THE PREFERRED EMBODIMENT

An estimation requesting method and system according to a first embodiment of the present invention will be hereinafter described with reference to the accompanying drawings.

First Embodiment

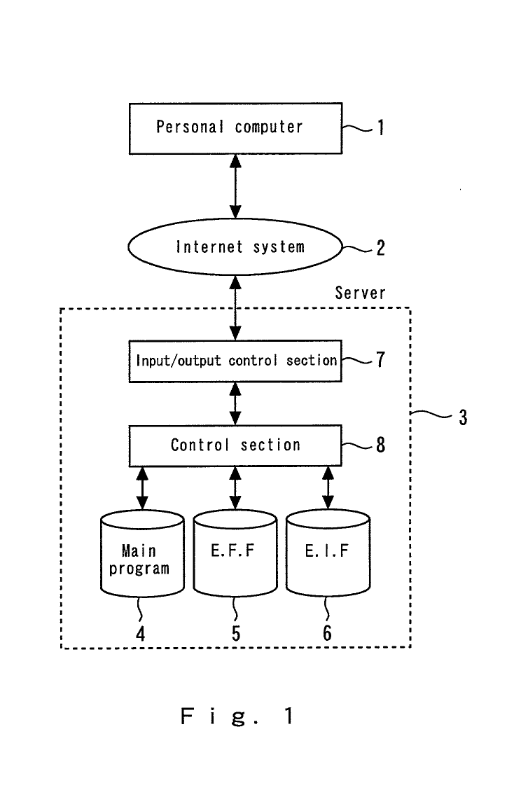

FIG. 1 is a schematic diagram showing the configuration of the embodiment.

In this drawing, reference numeral 1 denotes a personal computer as a terminal apparatus that is manipulated by a person (user) who needs information. Reference numeral 2 denotes an Internet system. Reference numeral 3 denotes a server of a order recipient company (an information supplier) that is connected to the personal computer 1 via the Internet. The server 3 is composed of the following components. Reference numeral 4 denotes a main program in which a series of processing contents are set. Reference numeral 5 denotes an estimation requesting document form information file (E.F.F) for setting and storage of an estimation requesting document form. Reference numeral 6 denotes an estimation requesting document information file (E.I.F) for setting and storage of details of service contents that are to be input to the estimation requesting document form. The main program 4, the estimation requesting document form information file 5, and the estimation requesting document information file 6 are stored in respective prescribed storage means.

Reference numeral 7 denotes an input/output control section for urging, according to the main program 4, a user to input service contents which he wants to receive when the estimation requesting document form is called and displayed on the screen. Reference numeral 8 denotes a control section for performing processing according to the main program 4.

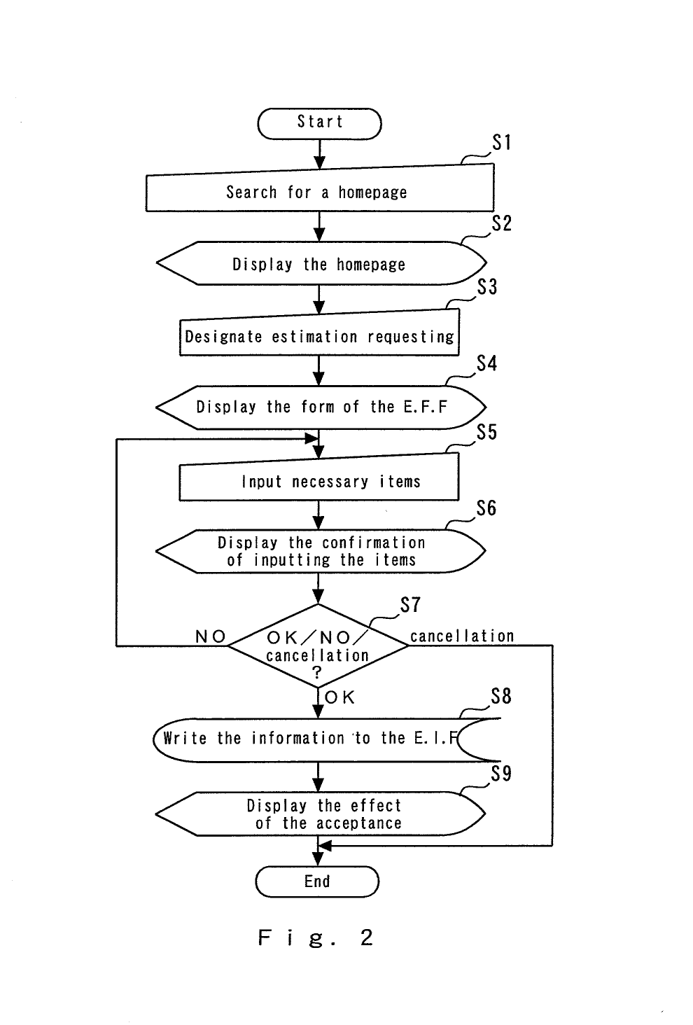

Next, the operation of this embodiment will be described by using a flow chart of FIG. 2. First, at step S1, by manipulating the personal computer 1 the user searches for (specifies a UCL) a homepage of a prescribed order recipient company (information supplying side) over the Internet 2. In response, the input/output control section 7 of the server 3 of the order recipient company starts to operate. In step S2, the homepage of the order recipient company thus searched for is displayed on the personal computer 1 of the user.

In step S3, estimation requesting is designated. In step S4, the estimation requesting document form is sent from the estimation document form information file 5 via the input/output control section 7 and the control section 8 and displayed on the screen.

In step S5, a display that urges the user to input desired service contents to respective spaces of the estimation requesting document form is made on the screen. In response, the user inputs necessary items (conditions) through the personal computer 1 according to the display on the screen.

Upon completion of the input of necessary items (conditions), in step S6 a display that urges the user to confirm the thus-input necessary items (conditions).

If the input contents are improper (NO) in step S7, the process returns to step S5, where necessary items (conditions) are input again. If cancellation is selected in step S7, the process is finished at this stage.

If the input contents are proper (OK), the process goes to step S8, where the input information is written to the estimation requesting document information file 6. In step S9, a display to the effect that the acceptance of estimation requesting has completed is made and the process is finished.

In the above estimation requesting method and system in electronic business according to the present invention, a user calls an estimation requesting document form from the homepage of a order recipient company over the Internet, inputs necessary items to it, and returns a completed estimation requesting document. Therefore,not only can estimation requesting be made online quickly, but also the time taken to obtain estimate information can be shortened. Since a user directly accesses the homepage of a order recipient company, his personal information can be secured, which allows the estimation requesting method and system of the invention to be applied to estimation requesting of insurance such as car insurance.

Obviously many modifications and variations of the present invention are possible in the light of the above teachings. It is therefore to be understood that within the scope of the appended claims the invention may by practiced otherwise than as specifically described.

The entire disclosure of a Japanese Patent Application No. 2000-377580, filed on Dec. 12, 2000 including specification, claims, drawings and summary, on which the Convention priority of the present application is based, are incorporated herein by reference in its entirety.

1. An estimation requesting method in electronic business, comprising the steps of:
storing in advance estimation requesting document form information in a server of an information supplier that is connected to an Internet;
calling an estimation requesting document form from a homepage of the information supplier by an information desiring person;
inputting prescribed items to the estimation requesting document form; and
sending a completed estimation requesting document to the information supplier,
whereby the information desiring person directly requests the information supplier to make an estimate.

2. The estimation requesting method according to claim 1, wherein a subject of estimation requesting is insurance such as car insurance.

3. An estimation requesting method in electronic business, comprising the steps of:
storing in advance estimation requesting document form information in a server of an information supplier that is connected to an Internet;
giving the server a function of urging an information desiring person to input desired service contents to an estimation requesting document form when the information desiring person has called the estimation requesting document form from a homepage of the information supplier;
inputting prescribed items to the estimation requesting document form; and
sending a completed estimation requesting document to the information supplier,
whereby the information desiring person directly requests the information supplier to make an estimate.

4. The estimation requesting method according to claim 3, wherein a subject of estimation requesting is insurance such as car insurance.

5. An estimation requesting system in electronic business, comprising:
a server of an information supplier connected to a terminal apparatus of an information desiring person through an Internet, wherein the server comprises,
a main program which is stored in advance in the server;
an estimation requesting document form information file which is stored in advance in the server;
an estimation requesting document information file, having service contents to be input to an estimation requesting document form, which is stored in advance in the server;
an input/output control section for urging the information desiring person to input desired service contents when he has called, through the terminal apparatus, the estimation requesting document form from a homepage of the information supplier; and
a control section for performing processing according to the main program.

6. The estimation requesting system according to claim 5, wherein a subject of estimation requesting is insurance such as car insurance.
